(19) United States
(12) Patent Application Publication
(10) Pub. No.: US 2025/0138918 A1
(43) Pub. Date: May 1, 2025

(54) SYSTEM AND METHODS FOR EVENT DRIVEN ARCHITECTURE

(71) Applicant: Fidelity Information Services, LLC, Jacksonville, FL (US)

(72) Inventors: Ranadhir GHOSH, St. Johns, FL (US); Gautam KUMAR, Bengaluru (IN); Prajwal M, Bengaluru (IN); Abhinav SHARMA, Pune (IN); John PLATAIS, Menomonee Falls, WI (US)

(21) Appl. No.: 19/006,711

(22) Filed: Dec. 31, 2024

Related U.S. Application Data
(63) Continuation-in-part of application No. 18/478,106, filed on Sep. 29, 2023.

(51) Int. Cl. G06F 9/54

(52) U.S. Cl. CPC G06F 9/546

(57) ABSTRACT

A computer-implemented method for determining a message in a message queue of an information technology system. The method may include receiving an information technology event data object in an object-relational database management system, the information technology event data object including metadata; determining a change to the object-relational database has occurred by implementing a change data capture platform; determining, using the change data capture platform, a log file of the change to the first table, the log file including the metadata from the information technology event data object; deploying the log file to a message queue; and processing, through a consumer module, the log file of the message queue to perform an action.

### CROSS-REFERENCE TO RELATED APPLICATION(S)

This patent application is a continuation-in-part of and claims the benefit of priority to U.S. application Ser. No. 18/478,106, filed on Sep. 29, 2023, the entirety of which is incorporated herein by reference.

### TECHNICAL FIELD

Various embodiments of the present disclosure relate generally to information technology (IT) management systems and, more particularly, to systems and methods for event driven architecture by implementing a message queue in an information technology management system.

### BACKGROUND

In computing systems, for example computing systems that perform financial services and electronic payment transactions, programing changes may occur. For example, software may be updated. Changes in the system may lead to, defects, issues, bugs or problems (collectively referred to as incidents) within the system. These incidents may occur at the time of a software change or at a later time. These incidents may be costly for the company, as users may not be able to use the services, and due to resources expended by the company to resolve the incidents.

These incidents in the system may need to be examined and resolved in order to have the software services perform correctly. Time may be spent by, for example, incident resolution teams, determining what issues arose within the software services. The faster an incident may be resolved, the less potential costs a company may incur. Thus, promptly identifying and fixing such incidents (e.g., writing new code or updating deployed code) may be important to a company.

Conventional information technology (IT) systems may struggle to responds to IT events. These systems may have slow response times to IT events and may not be configured to respond to the events in real-time or near real-time. The present disclosure is directed to addressing this and other drawbacks to the existing computing system incident analysis techniques.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

In some aspects, the techniques described herein relate to a method for determining a message in a message queue of an information technology system, the method including: receiving an information technology event data object in a first table of an object-relational database management system, the information technology event data object including metadata; determining a change to the object-relational database has occurred by implementing a change data capture platform; determining, using the change data capture platform, a log file of the change to the first table, the log file including the metadata from the information technology event data object; deploying the log file to a message queue; and processing, through a consumer module, the log file of the message queue to perform an action.

In some aspects, the techniques described herein relate to a method, wherein the information technology event data object corresponds to incident data, alert data, problem data, change data, anomaly data, or an action performed by the information technology system.

In some aspects, the techniques described herein relate to a method, wherein the information technology event data object is stored in a first table of the object-relational database management system, wherein the first table only stores a particular data type.

In some aspects, the techniques described herein relate to a method, wherein the event data object is received from one or more data sources and processed prior to being stored in the object-relational database management system.

In some aspects, the techniques described herein relate to a method, wherein the change data capture platform determines changes to the object-relational database in real-time.

In some aspects, the techniques described herein relate to a method, wherein the log file indicates whether the information technology event data object is new, an update, or cancels a section of the first table of the object-relational database management system.

In some aspects, the techniques described herein relate to a method, wherein the deploying the log file to the message queue further includes: accessing, by a connector, a conversion chart, the conversion chart including logic for converting data from the object-relational database to the message queue; and evaluating a ternary expression located in the log file, by implementing the conversion chart, to determine a topic of the message queue to which deploy the log file.

In some aspects, the techniques described herein relate to a method, wherein the message queue includes a plurality of topics, and each of the plurality of topics corresponds to a specific table within the object-relational database.

In some aspects, the techniques described herein relate to a method, wherein the processing the log file further includes: outputting an alert to an external user, through a user interface, of an occurrence of an information technology event associated with the information technology event data object.

In some aspects, the techniques described herein relate to a system for determining a message in a message queue of an information technology system, the system including: a memory having processor-readable instructions stored therein; and at least one processor configured to access the memory and execute the processor-readable instructions to perform operations including: receiving an information technology event data object in a first table of an object-relational database management system, the information technology event data object including metadata; determining a change to the object-relational database has occurred by implementing a change data capture platform; determining, using the change data capture platform, a log file of the change to the first table, the log file including the metadata from the information technology event data object; deploying the log file to a message queue; and processing, through a consumer module, the log file of the message queue to perform an action.

In some aspects, the techniques described herein relate to a system, wherein the information technology event data object corresponds to incident data, alert data, problem data, change data, anomaly data, or an action performed by the information technology system.

In some aspects, the techniques described herein relate to a system, wherein the event data object is received from one or more data sources and processed prior to being stored in the object-relational database management system.

In some aspects, the techniques described herein relate to a system, wherein the change data capture platform determines changes to the object-relational database in real-time.

In some aspects, the techniques described herein relate to a system, wherein the log file indicates whether the information technology event data object is new, an update, or cancels a section of the first table of the object-relational database management system.

In some aspects, the techniques described herein relate to a system, wherein the deploying the log file to the message queue further includes: accessing, by a connector, a conversion chart, the conversion chart including logic for converting data from the object-relational database to the message queue; and evaluating a ternary expression located in the log file, by implementing the conversion chart, to determine a topic of the message queue to which deploy the log file.

In some aspects, the techniques described herein relate to a system, wherein the processing the log file further includes: outputting an alert to an external user, through a user interface, of an occurrence of an information technology event associated with the information technology event data object.

In some aspects, the techniques described herein relate to a non-transitory computer readable medium configured to store processor-readable instructions which, when executed by at least one processor, cause the at least one processor to perform operations including: receiving an information technology event data object in a first table of an object-relational database management system, the information technology event data object including metadata; determining a change to the object-relational database has occurred by implementing a change data capture platform; determining, using the change data capture platform, a log file of the change to the first table, the log file including the metadata from the information technology event data object; deploying the log file to a message queue; and processing, through a consumer module, the log file of the message queue to perform an action.

In some aspects, the techniques described herein relate to a non-transitory computer readable medium, wherein the change data capture platform determines changes to the object-relational database in real-time.

In some aspects, the techniques described herein relate to a non-transitory computer readable medium, wherein the deploying the log file to the message queue further includes: accessing, by a connector, a conversion chart, the conversion chart including logic for converting data from the object-relational database to the message queue; and evaluating a ternary expression located in the log file, by implementing the conversion chart, to determine a topic of the message queue to which deploy the log file.

In some aspects, the techniques described herein relate to a non-transitory computer readable medium, wherein the processing the log file further includes: outputting an alert to an external user, through a user interface, of an occurrence of an information technology event associated with the information technology event data object.

### BRIEF DESCRIPTION OF THE DRAWINGS

The accompanying drawings, which are incorporated in and constitute a part of this specification, illustrate several embodiments and together with the description, serve to explain the principles of the disclosure.

FIG. 1 depicts an exemplary system overview for a data pipeline for an artificial intelligence model to analyze information technology (IT) data in a system, according to one or more embodiments.

FIG. 2A depicts an exemplary system for implementing an event driven architecture in IT system, according to one or more embodiments.

FIG. 2B depicts an exemplary message queue for an IT system, according to one or more embodiments.

FIG. 3 depicts a flowchart of a method for determining a message in a message queue of an information technology system, according to one or more embodiments.

FIG. 4 illustrates a computer system for executing the techniques described herein, according to one or more embodiments of the present disclosure.

### DETAILED DESCRIPTION OF EMBODIMENTS

Various embodiments of the present disclosure relate generally to information technology (IT) management systems and, more particularly, to systems and methods for event driven architecture by implementing a message queue in an information technology management system.

The subject matter of the present disclosure will now be described more fully with reference to the accompanying drawings that show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment, and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Software companies have been struggling to avoid outages from incidents that may be caused by upgrading software or hardware components, or changing a member of a team, for example. The system described herein may be configured to analyze and/or process event data for an Information Technology (IT) system. The system described herein may, for example receive a stream of event data over periods of time and/or set of batch data. This event data may further be described as IT event data. Event data may include, but is not limited: (1) an incident, (2) an alert, (3) change data, (4) a problem, and/or (5) an anomaly.

An incident may be an occurrence that can disrupt or cause a loss of operation, services, or functions of a system. Incidents may be manually reported by customers or personnel, may be automatically logged by internal systems, or may be captured in other ways. An incident may occur from factors such as hardware failure, software failure, software bugs, human error, and/or cyber attacks. Deploying, refactoring, or releasing software code may, for example, cause an incident. An incident may be detected during, for example, an outage or a performance change. An incident may include characteristics, where an incident characteristic may refer to the quality or traits associated with an incident. For example, incident characteristics may include, but are not limited to, the severity of an incident, the urgency of an incident, the complexity of an incident, the scope of an incident, the cause of an incident, and/or what configurable item corresponds to the incident (e.g., what systems/platforms/products etc. are affected by the incident), how it is described in freeform text, what business segment is effected, what category/subcategory is affected, and/or what assigned group is the incident.

An alert may refer to a notification that informs a system or user of an event. An alert may include a collection of events representing a deviation from normal behavior for a system. For example, an alert may include metadata including a short field description that includes free from text fields (e.g., a summary of the alert), first occurrences, time stamps, an alert key, etc. Understanding the different types of alerts within a system from various perspectives may assist in resolving incidents.

Change data may refer to information that describes a modification made to data within a system or database. Change data may track the changes that occur over one or more periods of time. Problem data may refer to any data that causes issues or impedes a systems normal operations. Anomaly data may refer to data that indicates a deviation of a system from a standard or normal operation.

The event data may further include entities effected by the event and their respective relationships. Event data may be associated with one or more configurable items (CIs). A configurable item (CI) may refer a component of a system that can be identified as a self-contained unit for purposes of change control and identification. For example, a particular application, service, particular product, server, may be defined by a CI.

Processing a vast amount of information, such as incidents, to produce meaningful and actionable insights in IT operations may be valuable to organizations. As IT management systems utilize sophisticated tools and sensors, billions of data points may be received, and information overload may become an issue to be resolved. Software companies have struggled to have systems capable of analyzing IT event data. In particular, conventional systems struggle to provide real-time processed data to users or external systems. An IT management system may receive event data (e.g., data objects indicating occurrences of event) at invariable rates throughout the day. It may be important for received IT event data to be routed efficiently, quickly, and to a correct location. For example, it may important to present user or external systems with real-time processed and analyzed data.

Conventional systems may obtain and route data at set intervals to a user or service. For example, conventional systems may implement JavaCron jobs algorithms to obtain processed data using a rest Application Programming Interface (API) call in a scheduled manner and dump these data to temporary tables in object-relational database management systems. Only when an action is triggered from a user through an application, will corresponding APIs gets called and data may fetched from temporary tables of which gets displayed in a user interface (UI). In these conventional systems the data available to the user might not be the real time data. As a result, users may not have access to the most updated data.

The system and methods described herein may provide to one or more users real-time processed and analyzed data. For example, the systems and methods described herein may have an Event Drive Architecture (EDA) that implement a message queue. The EDA may be a software pattern that enable the system to detect “events”, significant changes in a state or an update, and respond to them in real-time or near real-time. In contrast to the traditional “request/response” architecture, the system described herein implementing EDAs may provide faster response times, a more seamless user experience, and better scalability without blocked thread waiting. The message queue described herein may implement a distributed streaming platform as described in greater detail below.

One or more embodiments of system described herein may intake data received from a source database, and route the data to a particular topic in a message queue. This may be done implementing change data capture, advantageously creating updates in a message queue as data is received or updated in the source database. This may allow for data to be output to one or more notification systems immediately upon data intake in the source database.

Advantageously the systems and methods described herein may apply change data capture to identify and capture changes made to data in a database. These changes to a source database may be propagated as events in a message queue that may be accessed by one or more consumer applications, providing real-team updates of a data source to one or more consumer applications. This may allow for the data pipeline described herein to provide real-time updates to users and external systems as data is received, changed, or deleted by one or more data sources.

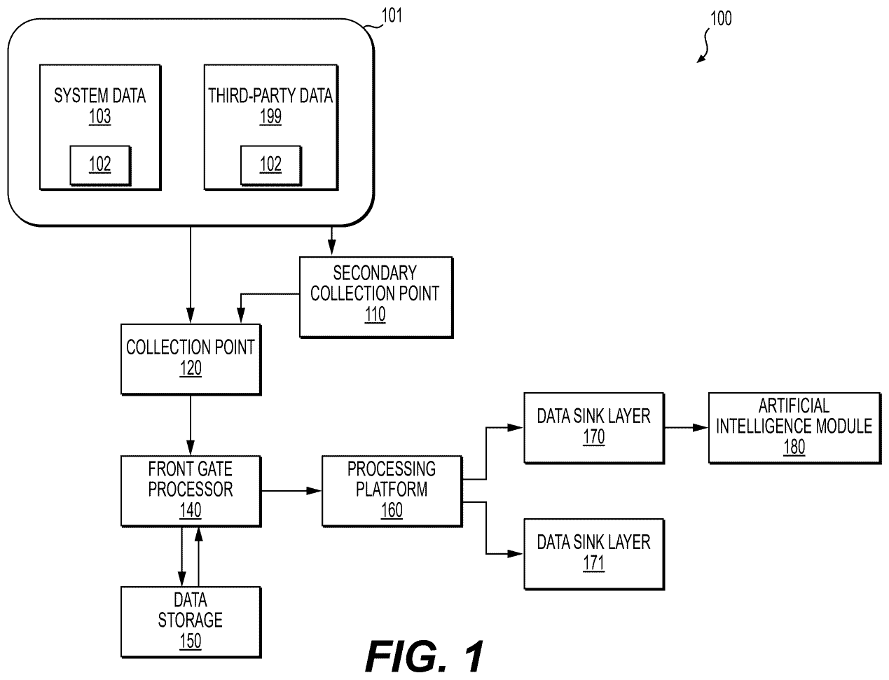

FIG. 1 depicts an exemplary system overview for a data pipeline for an artificial intelligence module to predict and troubleshoot incidents in a system, according to one or more embodiments. The data pipeline system 100 may be a platform with multiple interconnected components. The data pipeline system 100 may include one or more servers, intelligent networking devices, computing devices, components, and corresponding software for aggregating and processing data.

As shown in FIG. 1, a data pipeline system 100 may include a data source 101, a collection point 120, a secondary collection point 110, a front gate processor 140, data storage 150, a processing platform 160, a data sink layer 170, a data sink layer 171, and an artificial intelligence module 180.

The data source 101 may include in-house data 103 and third party data 199. The in-house data 103 may be a data source directly linked to the data pipeline system 100. Third party data 199 may be a data source connected to the data pipeline system 100 externally as will be described in greater detail below.

Both the in-house data 103 and third party data 199 of the data source 101 may include incident data 102. Incident data 102 may include incident reports with information for each incident provided with one or more of an incident number, closed date/time, category, close code, close note, long description, short description, root cause, or assignment group. Incident data 102 may include incident reports with information for each incident provided with one or more of an issue key, description, summary, label, issue type, fix version, environment, author, or comments. Incident data 102 may include incident reports with information for each incident provided with one or more of a file name, script name, script type, script description, display identifier, message, committer type, committer link, properties, file changes, or branch information. Incident data 102 may include one or more of real-time data, market data, performance data, historical data, utilization data, infrastructure data, or security data. These are merely examples of information that may be used as data, and the disclosure is not limited to these examples.

Incident data 102 may be generated automatically by monitoring tools that generate alerts and incident data to provide notification of high-risk actions, failures in IT environment, and may be generated as tickets. Incident data may include metadata, such as, for example, text fields, identifying codes, and time stamps.

The in-house data 103 may be stored in a relational database including an incident table. The incident table may be provided as one or more tables, and may include, for example, one or more of problems, tasks, risk conditions, incidents, or changes. The relational database may be stored in a cloud. The relational database may be connected through encryption to a gateway. The relational database may send and receive periodic updates to and from the cloud. The cloud may be a remote cloud service, a local service, or any combination thereof. The cloud may include a gateway connected to a processing API configured to transfer data to the collection point 120 or a secondary collection point 110. The incident table may include incident data 102.

Data pipeline system 100 may include third party data 199 generated and maintained by third party data producers. Third party data producers may produce incident data 102 from Internet of Things (IoT) devices, desktop-level devices, and sensors. Third party data producers may include but are not limited to Tryambak, Appneta, Oracle, Prognosis, ThousandEyes, Zabbix, ServiceNow, Density, Dyatrace, etc. The incident data 102 may include metadata indicating that the data belongs to a particular client or associated system.

The data pipeline system 100 may include a secondary collection point 110 to collect and pre-process incident data 102 from the data source 101. The secondary collection point 110 may be utilized prior to transferring data to a collection point 120. The secondary collection point 110 point may, for example, be an Apache MiNiFi software. In one example, the secondary collection point 110 may run on a microprocessor for a third party data producer. Each third party data producer may have an instance of the secondary collection point 110 running on a microprocessor. The secondary collection point 110 may support data formats including but not limited to JSON, CSV, Avro, ORC, HTML, XML, and Parquet. The secondary collection point 110 may encrypt incident data 102 collected from the third party data producers. The secondary collection point 110 may encrypt incident data, including, but not limited to, Mutual Authentication Transport Layer Security (mTLS), HTTPs, SSH, PGP, IPsec, and SSL. The secondary collection point 110 may perform initial transformation or processing of incident data 102. The secondary collection point 110 may be configured to collect data from a variety of protocols, have data provenance generated immediately, apply transformations and encryptions on the data, and prioritize data.

The data pipeline system 100 may include a collection point 120. The collection point 120 may be a system configured to provide a secure framework for routing, transforming, and delivering data across from the data source 101 to downstream processing devices (e.g., the front gate processor 140). The collection point 120 may, for example, be a software such as Apache NiFi. The collection point 120 may receive raw data and the data's corresponding fields such as the source name and ingestion time. The collection point 120 may run on a Linux Virtual Machine (VM) on a remote server. The collection point 120 may include one or more nodes. For example, the collection point 120 may receive incident data 102 directly from the data source 101. In another example, the collection point 120 may receive incident data 102 from the secondary collection point 110. The secondary collection point 110 may transfer the incident data 102 to the collection point 120 using, for example, Site-to-Site protocol. The collection point 120 may include a flow algorithm. The flow algorithm may connect different processors, as described herein, to transfer and modify data from one source to another. For each third party data producer, the collection point 120 may have a separate flow algorithm. Each flow algorithm may include a processing group. The processing group may include one or more processors. The one or more processors may, for example, fetch incident data 102 from the relational database. The one or more processors may utilize the processing API of the in-house data 103 to make an API call to a relational database to fetch incident data 102 from the incident table. The one or more processors may further transfer incident data 102 to a destination system such as a front gate processor 140. The collection point 120 may encrypt data through HTTPS, Mutual Authentication Transport Layer Security (mTLS), SSH, PGP, IPsec, and/or SSL, etc. The collection point 120 may support data formats including but not limited to JSON, CSV, Avro, ORC, HTML, XML, and Parquet. The collection point 120 may be configured to write messages to clusters of a front gate processor 140 and communication with the front gate processor 140.

The data pipeline system 100 may include a distributed event streaming platform such as a front gate processor 140. The front gate processor 140 may be connected to and configured to receive data from the collection point 120. The front gate processor 140 may be implemented in an Apache Kafka cluster software system. The front gate processor 140 may include one or more message brokers and corresponding nodes. The message broker may, for example, be an intermediary computer program module that translates a message from the formal messaging protocol of the sender to the formal messaging protocol of the receiver. The message broker may be on a single node in the front gate processor 140. A message broker of the front gate processor 140 may run on a virtual machine (VM) on a remote server. The collection point 120 may send the incident data 102 to one or more of the message brokers of the front gate processor 140. Each message broker may include a topic to store similar categories of incident data 102. A topic may be an ordered log of events. Each topic may include one or more sub-topics. For example, one sub-topic may store incident data 102 relating to network problems and another topic may store incident data 102 related to security breaches from third party data producers. Each topic may further include one or more partitions. The partitions may be a systematic way of breaking the one topic log file into many logs, each of which can be hosted on a separate server. Each partition may be configured to store as much as a byte of incident data 102. Each topic may be partitioned evenly between one or more message brokers to achieve load balancing and scalability. The front gate processor 140 may be configured to categorize the received data into a plurality of client categories, thereby forming a plurality of datasets associated with the respective client categories. These datasets may be stored separately within the storage device as described in greater detail below. The front gate processor 140 may further transfer data to storage and to processors for further processing.

For example, the front gate processor 140 may be configured to assign particular data to a corresponding topic. Alert sources may be assigned to an alert topic, and incident data may be assigned to an incident topic. Change data may be assigned to a change topic. Problem data may be assigned to a problem topic.

The data pipeline system 100 may include a software framework for data storage 150. The data storage 150 may be configured for long term storage and distributed processing. The data storage 150 may be implemented using, for example, Apache Hadoop. The data storage 150 may store incident data 102 transferred from the front gate processor 140. In particular, data storage 150 may be utilized for distributed processing of incident data 102, and Hadoop distributed file system (HDFS) within the data storage may be used for organizing communications and storage of incident data 102. For example, the HDFS may replicate any node from the front gate processor 140. This replication may protect against hardware or software failures of the front gate processor 140. The processing may be performed in parallel on multiple servers simultaneously.

The data storage 150 may include an HDFS that is configured to receive the metadata (e.g., incident data). The data storage 150 may further process the data utilizing a MapReduce algorithm. The MapReduce algorithm may allow for parallel processing of large data sets. The data storage 150 may further aggregate and store the data utilizing Yet Another Resource Negotiation (YARN). YARN may be used for cluster resource management and planning tasks of the stored data. For example, a cluster computing framework, such as the processing platform 160, may be arranged to further utilize the HDFS of the data storage 150. For example, if the data source 101 stops providing data, the processing platform 160 may be configured to retrieve data from the data storage 150 either directly or through the front gate processor 140. The data storage 150 may allow for the distributed processing of large data sets across clusters of computers using programming models. The data storage 150 may include a master node and an HDFS for distributing processing across a plurality of data nodes. The master node may store metadata such as the number of blocks and their locations. The main node may maintain the file system namespace and regulate client access to said files. The main node may comprise files and directories and perform file system executions such as naming, closing, and opening files. The data storage 150 may scale up from a single server to thousands of machines, each offering local computation and storage. The data storage 150 may be configured to store the incident data in an unstructured, semi-structured, or structured form. In one example, the plurality of datasets associated with the respective client categories may be stored separately. The master node may store the metadata such as the separate dataset locations.

The data pipeline system 100 may include a real-time processing framework, e.g., a processing platform 160. In one example, the processing platform 160 may be a distributed dataflow engine that does not have its own storage layer. For example, this may be the software platform Apache Flink. In another example, the software platform Apache Spark may be utilized. The processing platform 160 may support stream processing and batch processing. Stream processing may be a type of data processing that performs continuous, real-time analysis of received data. Batch processing may involve receiving discrete data sets processed in batches. The processing platform 160 may include one or more nodes. The processing platform 160 may aggregate incident data 102 (e.g., incident data 102 that has been processed by the front gate processor 140) received from the front gate processor 140. The processing platform 160 may include one or more operators to transform and process the received data. For example, a single operator may filter the incident data 102 and then connect to another operator to perform further data transformation. The processing platform 160 may process incident data 102 in parallel. A single operator may be on a single node within the processing platform 160. The processing platform 160 may be configured to filter and only send particular processed data to a particular data sink layer. For example, depending on the data source of the incident data 102 (e.g., whether the data is in-house data 103 or third party data 199), the data may be transferred to a separate data sink layer (e.g., the data sink layer 170, or data sink layer 171). Further, additional data that is not required at downstream modules (e.g., at the artificial intelligence module 180) may be filtered and excluded prior to transferring the data to a data sink layer.

The processing platform 160 may perform three functions. First, the processing platform 160 may perform data validation. The data's value, structure, and/or format may be matched with the schema of the destination (e.g., the data sink layer 170). Second, the processing platform 160 may perform a data transformation. For example, a source field, target field, function, and parameter from the data may be extracted. Based upon the extracted function of the data, a particular transformation may be applied. The transformation may reformat the data for a particular use downstream. A user may be able to select a particular format for downstream use. Third, the processing platform 160 may perform data routing. For example, the processing platform 160 may select the shortest and/or most reliable path to send data to a respective sink layer (e.g., the data sink layer 170 and/or the data sink layer 171).

In one example, the processing platform 160 may be configured to transfer particular sets of data to a data sink layer. For example, the processing platform 160 may receive input variables for a particular artificial intelligence module 180. The processing platform 160 may then filter the data received from the front gate processor 140 and only transfer data related to the input variables of the artificial intelligence module 180 to a data sink layer.

The data pipeline system 100 may include one or more data sink layers (e.g., the data sink layer 170 and data sink layer 171). Incident data 102 processed from processing platform 160 may be transmitted to and stored in the data sink layer 170. In one example, the data sink layer 171 may be stored externally on a particular client's server. The data sink layer 170 and data sink layer 171 may be implemented using a software such as, but not limited to, PostgreSQL, HIVE, Kafka, OpenSearch, and Neo4j. The data sink layer 170 may receive in-house data 103, which have been processed and received from the processing platform 160. The data sink layer 171 may receive third party data 199, which have been processed and received from the processing platform 160. The data sink layers may be configured to transfer incident data 102 to an artificial intelligence module 180. The data sink layers may be data lakes, data warehouses, or cloud storage systems. Each data sink layer may be configured to store incident data 102 in both a structured or unstructured format. The data sink layer 170 may store incident data 102 with several different formats. For example, the data sink layer 170 may support data formats such as JavaScript Objection Notation (JSON), comma-separated value (CSV), Avro, Optimized Row Columnar (ORC), Hypertext Markup Language (HTML), Extensible Markup Language (XML), or Parquet, etc. The data sink layer (e.g., the data sink layer 170 or data sink layer 171), may be accessed by one or more separate components. For example, the data sink layer may be accessed by a Non-structured Query language (“NoSQL”) database management system (e.g., a Cassandra cluster), a graph database management system (e.g., Neo4j cluster), further processing programs (e.g., Kafka+Flink programs), and a relation database management system (e.g., PostgresSQL cluster). Further processing may then be performed prior to the processed data being received by an artificial intelligence module 180.

The data pipeline system 100 may include an artificial intelligence module 180. The artificial intelligence module 180 may include a machine-learning component (e.g., one or more machine learning models). The artificial intelligence module 180 may use the received data in order to train and/or use a machine learning model. The machine learning model may be, for example, a neural network. Nonetheless, it should be noted that other machine learning techniques and frameworks may be used by the artificial intelligence module 180 to perform the methods contemplated by the present disclosure. For example, the systems and methods may be realized using other types of supervised and unsupervised machine learning techniques such as regression problems, random forest, cluster algorithms, principal component analysis (PCA), reinforcement learning, or a combination thereof. The artificial intelligence module 180 may be configured to extract and receive data from the data sink layer 170.

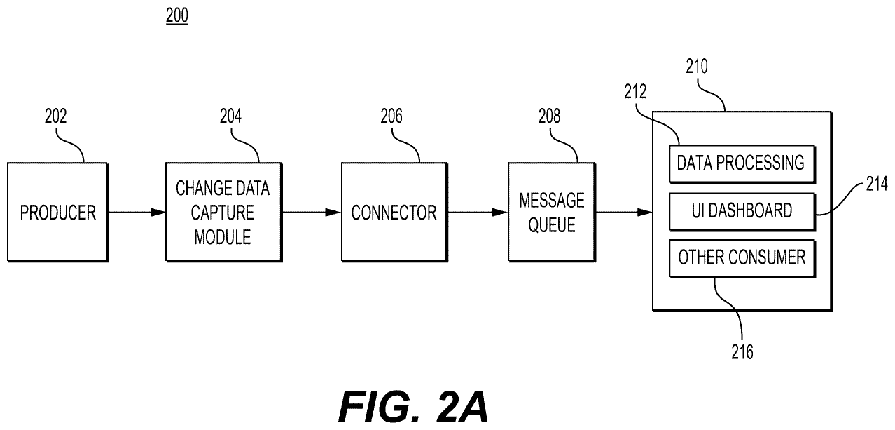

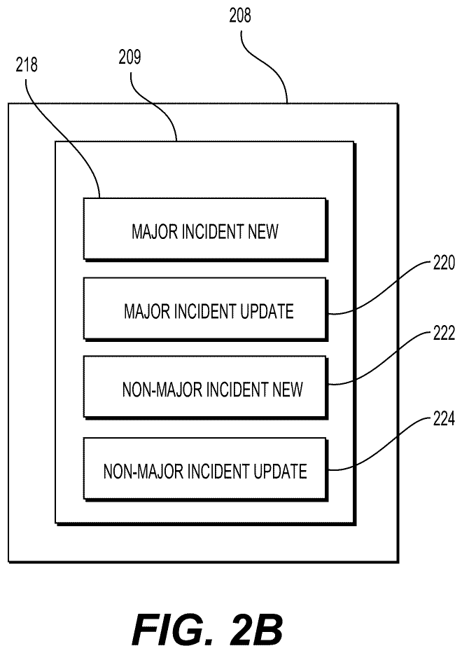

In certain embodiments, the system (e.g., the data pipeline system 100) may be configured to implement EDA as software pattern that enable us to detect “events”, significant changes in a state or an update, and respond to them in real-time or near real-time. The system 200, described in FIG. 2A, may implement an EDA software pattern and a message queue.

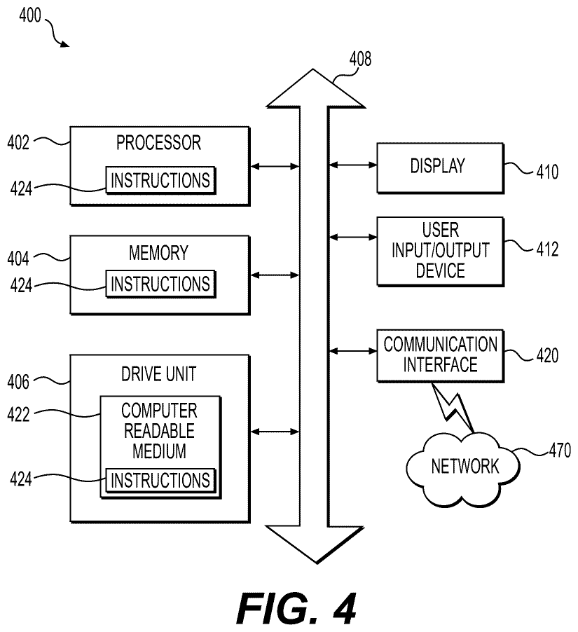

FIG. 2A depicts an exemplary system 200 for event driven architecture implementing a message queue, according to one or more embodiments. The system 200 may be implemented by aspects or modules of the data pipeline system 100 from FIG. 1 or by any computing system capable of performing the procedures (e.g., a computer system 400 of FIG. 4). The system 200 may include a producer 202, a change data capture module 204, a connector 206, a message queue 208, and one or more consumer applications 210.

The producer 202 may be an entity that generates and publishes events related to IT event data. The IT event data may include metadata associated with the IT event data. The data may be recorded as data objects. For example, the producer 202 may receive IT event data from the data source 101 of FIG. 1. In some examples, the data may be transferred to the producer 202 by the collection point 120. The producer 202 may, for example, be an object-relation database management systems that is configured to store a wide variety of data types including all types of IT event data. The producer 202 may include a plurality of tables, wherein tables correspond to specific external sources and types of data. For example, the producer 202 may include a table for all incident data received for a particular external source. In some examples, the producer 202 may be implemented by PostgreSQL, MySQL, or MongoDB software applications. The producer 202 may include one or more log files (e.g., a Write-Ahead log) that captures all changes (e.g., new data, updated data, or deletion of data) to the plurality of tables within the producer 202. The producer 202 may include a logical replication slot that allows for the change data capture module 204 to access the one or more logs of the producer 202.

The change data capture module 204 may include one or more servers or tools meant to monitor and capture changes made to the producer 202 in real time. The change data capture module 204 may be the event driven architecture aspect of the system described herein. The change data capture module 204 may track new entries, updates, or deletions to each of the plurality of tables of the producer 202. In some examples, the change data capture module 204 may be implemented by Debezium open source software. The change data capture module 204 may allow for efficient and real time data synchronization of the producer 202 with downstream components (e.g., the message queue 208) by capturing and streaming producer 202 changes in real time. The change data capture module 204 may include one or more change data capture connectors connected to the producer 202 and used as change data capture, capturing all updates (e.g., new data, updates, or deletion of data) in the plurality of tables of the producer 202. The change data capture connectors may be configured to extract the log file information to the change data capture module 204. The change data capture connector may monitor the one or more log files of the producer 202 to capture any updates to the producer 202. Reading and extracting from the log files, rather than querying the database directly, may minimize any impact on the producer 202, making it scalable and suitable for the high-volume of data that the producer 202 may receive.

The change data capture connector of the change data capture module 204 may be configured to, upon detecting an entry to a log file of the producer 202, determine a log file. The determined log file may be a copy of all data from the log file of the producer 202 with all relevant (e.g., new, updated, or canceled data). The determined log file may be in JavaScript Object Notation (JSON) format. The change data capture connector of the change data capture module 204 may allow for the monitoring and creation of log files for changes to the producer 202 in real time.

The system 200 may include the connector 206. The connector 206 may integrate the change data capture module 204 with the message queue 208. The connector 206 may be implemented by Kafka Connect software. In some examples, the connector 206 may be integrated into the change data capture module 204. The connector 206 may include pre-built or custom developed components, referred to as conversion charts, that define how data from the producer 202 should be input into the message queue 208. The connector 206 may deploy data (e.g., the log files determined by the change data capture module 204) to respective topics of the message queue 208 based on the conversion chart.

The connector 206 conversion chart may specific necessary configurations of data in the producer 202, and list respective connection details, broker information, and topics of the message queue 208. The connector 206 may ensure that data received by the producer 202 is stored in a correct topic of the message queue 208.

An exemplary conversion chart of the connector 206 may be displayed in table 1 below.

TABLE 1

| Name | dbz-test-connector |
|---|---|
| connector.class | io.debezium.connector.postgresql.PostgresConnector |
| plugin.name | Pgoutput |
| tasks.max | 1 |
| database.hostname | Hostname |
| database.port | 5432 |
| database.user | Postgres |
| database.password | Password |
| database.dbname | Database_name |
| database.server.name | ServerName |
| Transforms | Route |
| transforms.route.type | io.debezium.transforms.ContentBasedRouter |
| transforms.route.language | jsr223.groovy |
| transforms.route.topic.expression | operation == ‘new’ && new_major_incident ? |
| | ‘new_major_incident_topic’ : operation == ‘new’ && |
| | new_non_major_incident ? |
| | ‘new_non_major_incident_topic’ : operation == |
| | ‘update’ && updated_major_incident ? |
| | ‘updated_major_incident_topic’ : operation == |
| | ‘update’ && updated_non_major_incident ? |
| | ‘updated_non_major_incident_topic’ : null |

The message queue 208 may receive data logs from the connector 206 that include data initially received from producer 202. The message queue 208 may be implemented by Kafka software. The message queue 208 may include a respective topic for each table in the producer 202. The message queue 208 may be configured to generate new topics upon retrieving information from the connector 206 that a new table was created in the producer 202. The message queue 208 may include one or more brokers that are responsible for storing and managing topics and their respective partitions. The brokers may further handle the reception, storage, and forwarding of messages received from the connector 206.

FIG. 2B displays the message queue 208 with an exemplary topic 209. The exemplary topic 209 may be an assigned topic to incident data for a particular system connected to the producer 202. The exemplary topic 209 may include a first partition 218 for new major incident data, a second partition 220 for major incident updates, a third partition 222 for new non-major incidents, and a fourth partition 224 for updates to non-major incidents. As incident data is received by the producer 202 for the particular system, the change data capture module 204 and connector 206 may work to extract the log files of the data, and based on the conversion chart in the connector 206, assign data to the exemplary topic 209 and respective partitions. For example, if a previously recorded major incident of the particular system receives updated data, this data, in the form of a log file, may be transferred to the second partition 220. Respective consumer applications connected to the topics may then be notified via the message queue 208.

The one or more consumer applications 210 may include one or more entities that subscribe to and process updates to the message queue 208. For example, the one or more consumer applications 210 may include a data processing module 212, a user interface (UI) dashboard 214, and/or other consumer device 216. The data processing module 212 may for example be implemented by PyFlink and be configured to perform further stream and batch processing of the data received by the producer 202. The UI dashboard 214 may include one or more user interfaces that may provide immediate updates as new data is received. The other consumer device 216 may include external servers or systems connected to the message queue, receiving now organized streamlined data.

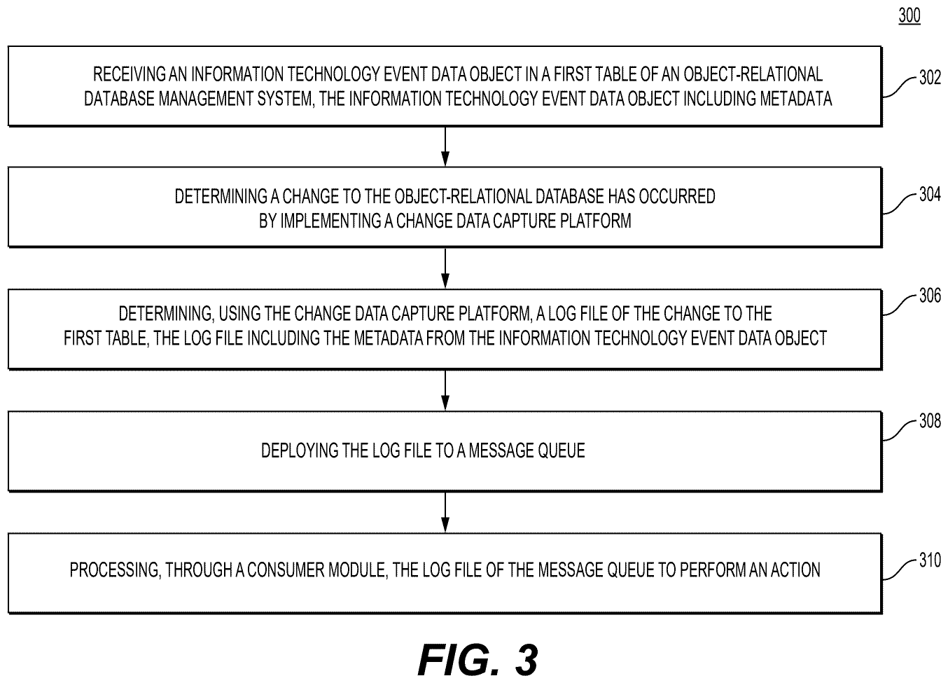

FIG. 3 depicts a flowchart 300 of a method for determining a message in a message queue of an information technology system, according to one or more embodiments. Determining a message in a message queue may include creating and implementing a message within an information technology system, The method described in flowchart 300 may be implemented by the data pipeline system 100 of FIG. 1 and/or by the system 200 of FIG. 2A.

Step 302 may include receiving an information technology event data object in a first table of an object-relational database management system (e.g., the producer 202), the information technology event data object including metadata. The information technology event data may include incident data, alert data, problem data, change data, anomaly data, or an action performed by the information technology system. The object-relational database management system may include separate tables for each of the different event data object types. The event data object may be received from one or more data sources and processed prior to being stored in the object-relational database management system. The processing may include applying one or more algorithms to perform data validation, data cleaning, initial transformation, data filtering, data enrichment, data parsing, data indexing, data timestamping, and/or feature parsing. This initial processing may lead to errors being identified, data being transformed to suitable formats for analysis, irrelevant data being removed, and making sure data conforms to expected standards.

Step 304 may include determining a change to the object-relational database has occurred by implementing a change data capture platform (e.g., the change data capture module 204). The change data capture platform may determine changes to the object-relational database in real-time.

Step 306 may include determining, using the change data capture platform, a log file of the change to the first table, the log file including the metadata from the information technology event data object. The log file indicates whether the information technology event data object is new, an update, or cancels a section of the first table of the object-relational database management system.

Step 308 may include deploying, using a connector (e.g., the connector 206), the log file to a topic of a message queue (e.g., the message queue 208). This may further include accessing, by the connector, a conversion chart, the conversion chart including logic for converting data from the object-relational database to the message queue and processing, through a consumer module, the log file of the message queue to perform an action. The message queue may a plurality of topics, and each of the plurality of topics corresponds to a specific table within the object-relational database.

Step 310 may include processing, through a consumer module (e.g., the one or more consumer applications 210), the log file of the message queue to perform an action. This may include alerting an external user, through a user interface (e.g., the UI dashboard 214), of the occurrence of an information technology event associated with the information technology event data object.

In an exemplary scenario, new incident data (e.g., event data objects) may be received as depicted in table 2 below. These may represent new incidents and their corresponding metadata for a particular system. Table 2 may display exemplary metadata associated with an incident data object, which may include an incident number, an indication of whether the incident is major, a timestamp, a status of the incident, and a description.

TABLE 2

| Number | Major | Opened_At | Status | Description |
|---|---|---|---|---|
| IN12344 | Yes | Jan. 4, 2024 | In | Software is |
| | | 12:20 PM | Progress | unable to connect |
| | | | | to system B. |
| IN12345 | No | Jan. 3, 2024 | In | System X, |
| | | 11:08 PM | Progress | specific |
| | | | | application Y, in |
| | | | | product |
| | | | | environment - |
| | | | | Missing financial |
| | | | | message from |
| | | | | bank for |
| | | | | Feb. 1, 2024 |

Once the exemplary table 2 is received by the producer 202, the change data capture module 204 may immediately extract the log files and the connector 206 may evaluate the ternary expression provided in property files of the conversion chart, and route the data shown in table 2 to a respective incident topics of message queue 208 associated the system. In particular, the top data object may be routed to the first partition 218 as it may be a new incident (as indicated by the major status). The second data object may be routed to the third partition 222 as it may be a new non-major incident.

In the same scenario, at a later time, an update may be received for the two data objects described in table 2. This update may be depicted in table 3 below, where the status of both incidents was updated.

TABLE 3

| Number | Major | Opened_At | Status | Description |
|---|---|---|---|---|
| IN12344 | Yes | Jan. 4, 2024 | On hold | Software is |
| | | 12:20 PM | | unable to |
| | | | | connect to |
| | | | | system B. |
| IN12345 | No | Jan. 3, 2024 | On hold | System X, |
| | | 11:08 PM | | specific |
| | | | | application Y, in |
| | | | | product |
| | | | | environment - |
| | | | | Missing |
| | | | | financial |
| | | | | message from |
| | | | | bank for |
| | | | | Feb. 1, 2024 |

When the producer 202 receives the updated data objects as shown in table 3, the method described in FIG. 3 may be applied to insert the respective data objects with their corresponding information into the respective partitions of the message queue 208 (e.g., the second partition 220 for the first data object, and the fourth partition 224 for the second data object). The message queue is thus updated to include a new record containing the operation that happened (e.g., an update), the old data, and the new data record to which the data was updated.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 404 includes a cache or random-access memory for the processor 402. In alternative implementations, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the programmed processor 402 executing the instructions stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel payment and the like.

As shown, the computer system 400 may further include a display unit 410, such as a liquid crystal display (LCD), an organic light emitting diode (OLED), a flat panel display, a solid-state display, a cathode ray tube (CRT), a projector, a printer or other now known or later developed display device for outputting determined information. The display unit 410 may act as an interface for the user to see the functioning of the processor 402, or specifically as an interface with the software stored in the memory 404 or in a disc or optical drive unit 406.

Additionally or alternatively, the computer system 400 may include an input/output device 412 configured to allow a user to interact with any of the components of the computer system 400. The input/output device 412 may be a number pad, a keyboard, or a cursor control device, such as a mouse, or a joystick, touch screen display, remote control, or any other device operative to interact with the computer system 400.

The disk or optical drive unit 406 may include a computer-readable medium 422 in which one or more sets of instructions 424, e.g., software, can be embedded. Further, the instructions 424 may embody one or more of the methods or logic as described herein. The instructions 424 may reside completely or partially within the memory 404 and/or within the processor 402 during execution by the computer system 400. The memory 404 and the processor 402 also may include computer-readable media as discussed above.

In some systems, a computer-readable medium 422 includes instructions 424 or receives and executes instructions 424 responsive to a propagated signal so that a device connected to a network 470 can communicate voice, video, audio, images, or any other data over the network 470. Further, the instructions 424 may be transmitted or received over the network 470 via a communication port or interface 420, and/or using a bus 408. The communication port or interface 420 may be a part of the processor 402 or may be a separate component. The communication port 420 may be created in software or may be a physical connection in hardware. The communication port 420 may be configured to connect with a network 470, external media, the display unit 410, or any other components in the computer system 400, or combinations thereof. The connection with the network 470 may be a physical connection, such as a wired Ethernet connection or may be established wirelessly as discussed below. Likewise, the additional connections with other components of the computer system 400 may be physical connections or may be established wirelessly. The network 470 may alternatively be directly connected to the bus 408.

While the computer-readable medium 422 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 422 may be non-transitory, and may be tangible.

The computer-readable medium 422 can include a solid-state memory such as a memory card or other package that houses one or more non-volatile read-only memories. The computer-readable medium 422 can be a random-access memory or other volatile re-writable memory. Additionally or alternatively, the computer-readable medium 422 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 400 may be connected to one or more networks 470. The network 470 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 470 may include wide area networks (WAN), such as the Internet, local area networks (LAN), campus area networks, metropolitan area networks, a direct connection such as through a Universal Serial Bus (USB) port, or any other networks that may allow for data communication. The network 470 may be configured to couple one computing device to another computing device to enable communication of data between the devices. The network 470 may generally be enabled to employ any form of machine-readable media for communicating information from one device to another. The network 470 may include communication methods by which information may travel between computing devices. The network 470 may be divided into sub-networks. The sub-networks may allow access to all of the other components connected thereto or the sub-networks may restrict access between the components. The network 470 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel payment. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP, etc.) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosed embodiments are not limited to any particular implementation or programming technique and that the disclosed embodiments may be implemented using any appropriate techniques for implementing the functionality described herein. The disclosed embodiments are not limited to any particular programming language or operating system.

It should be appreciated that in the above description of exemplary embodiments, various features of the embodiments are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that a claimed embodiment requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment.

Furthermore, while some embodiments described herein include some but not other features included in other embodiments, combinations of features of different embodiments are meant to be within the scope of the present disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the function.

In the description provided herein, numerous specific details are set forth. However, it is understood that embodiments of the present disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the present disclosure, those skilled in the art will recognize that other and further modifications may be made thereto without departing from the spirit of the present disclosure, and it is intended to claim all such changes and modifications as falling within the scope of the present disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A method for determining a message in a message queue of an information technology system, the method comprising:
receiving an information technology event data object in a first table of an object-relational database management system, the information technology event data object including metadata;
determining a change to the object-relational database has occurred by implementing a change data capture platform;
determining, using the change data capture platform, a log file of the change to the first table, the log file including the metadata from the information technology event data object;
deploying the log file to a message queue; and
processing, through a consumer module, the log file of the message queue to perform an action.

2. The method of claim 1, wherein the information technology event data object corresponds to incident data, alert data, problem data, change data, anomaly data, or an action performed by the information technology system.

3. The method of claim 1, wherein the information technology event data object is stored in a first table of the object-relational database management system, wherein the first table only stores a particular data type.

4. The method of claim 1, wherein the event data object is received from one or more data sources and processed prior to being stored in the object-relational database management system.

5. The method of claim 1, wherein the change data capture platform determines changes to the object-relational database in real-time.

6. The method of claim 1, wherein the log file indicates whether the information technology event data object is new, an update, or cancels a section of the first table of the object-relational database management system.

7. The method of claim 1, wherein the deploying the log file to the message queue further includes:
accessing, by a connector, a conversion chart, the conversion chart including logic for converting data from the object-relational database to the message queue; and
evaluating a ternary expression located in the log file, by implementing the conversion chart, to determine a topic of the message queue to which deploy the log file.

8. The method of claim 1, wherein the message queue includes a plurality of topics, and each of the plurality of topics corresponds to a specific table within the object-relational database.

9. The method of claim 1, wherein the processing the log file further includes:
outputting an alert to an external user, through a user interface, of an occurrence of an information technology event associated with the information technology event data object.

10. A computer-implemented system for determining a message in a message queue of an information technology system, the system comprising:
a memory having processor-readable instructions stored therein; and
at least one processor configured to access the memory and execute the processor-readable instructions to perform operations including:
receiving an information technology event data object in a first table of an object-relational database management system, the information technology event data object including metadata;
determining a change to the object-relational database has occurred by implementing a change data capture platform;
determining, using the change data capture platform, a log file of the change to the first table, the log file including the metadata from the information technology event data object;
deploying the log file to a message queue; and
processing, through a consumer module, the log file of the message queue to perform an action.

11. The system of claim 10, wherein the information technology event data object corresponds to incident data, alert data, problem data, change data, anomaly data, or an action performed by the information technology system.

12. The system of claim 10, wherein the event data object is received from one or more data sources and processed prior to being stored in the object-relational database management system.

13. The system of claim 10, wherein the change data capture platform determines changes to the object-relational database in real-time.

14. The system of claim 10, wherein the log file indicates whether the information technology event data object is new, an update, or cancels a section of the first table of the object-relational database management system.

15. The system of claim 10, wherein the deploying the log file to the message queue further includes:
accessing, by a connector, a conversion chart, the conversion chart including logic for converting data from the object-relational database to the message queue; and
evaluating a ternary expression located in the log file, by implementing the conversion chart, to determine a topic of the message queue to which deploy the log file.

16. The system of claim 10, wherein the processing the log file further includes:
outputting an alert to an external user, through a user interface, of an occurrence of an information technology event associated with the information technology event data object.

17. A non-transitory computer readable medium configured to store processor-readable instructions which, when executed by at least one processor, cause the at least one processor to perform operations including:
receiving an information technology event data object in a first table of an object-relational database management system, the information technology event data object including metadata;
determining a change to the object-relational database has occurred by implementing a change data capture platform;
determining, using the change data capture platform, a log file of the change to the first table, the log file including the metadata from the information technology event data object;
deploying the log file to a message queue; and
processing, through a consumer module, the log file of the message queue to perform an action.

18. The non-transitory computer readable medium of claim 17, wherein the change data capture platform determines changes to the object-relational database in real-time.

19. The non-transitory computer readable medium of claim 17, wherein the deploying the log file to the message queue further includes:
accessing, by a connector, a conversion chart, the conversion chart including logic for converting data from the object-relational database to the message queue; and
evaluating a ternary expression located in the log file, by implementing the conversion chart, to determine a topic of the message queue to which deploy the log file.

20. The non-transitory computer readable medium of claim 17, wherein the processing the log file further includes:
outputting an alert to an external user, through a user interface, of an occurrence of an information technology event associated with the information technology event data object.
